(19) United States
(12) Patent Application Publication
(10) Pub. No.: US 2016/0371991 A1
(43) Pub. Date: Dec. 22, 2016

(54) INSTRUCTIONAL CONTENT GENERATION FOR THE CHALLENGED

(71) Applicant: Laura J. Neff, Kinnelon, NJ (US)

(72) Inventor: Laura J. Neff, Kinnelon, NJ (US)

(21) Appl. No.: 15/256,673

(22) Filed: Sep. 5, 2016

Related U.S. Application Data
(60) Provisional application No. 62/310,833, filed on Mar. 21, 2016.

(51) Int. Cl. G09B 5/04; G06F 3/16; G06F 3/01

(52) U.S. Cl. CPC G09B 5/04; G06F 3/017; G06F 3/167

(57) ABSTRACT

Instructional content, e.g., a tutorial, can be generated for developmentally or mentally challenged people by recording images of a human subject in motion; processing the recorded images to determine gestures made by the human subject; synchronizing the recorded images with a narrative corresponding to the determined sequence of gestures; and storing the synchronized image-supported narrative to permit reproduction thereof on a processor-enabled user device.

### CROSS-REFERENCE TO RELATED APPLICATION

This application claims the benefit of U.S. Provisional Application No. 62/310,833 filed Mar. 21, 2016, the disclosure of which is incorporated herein by reference.

### BACKGROUND OF THE INVENTION

Field of the Invention

The subject matter of the present invention relates to a system, process and computer-readable tangible storage medium for generating instructional content, e.g., tutorials, and more specifically for generating instructional content for the developmentally or mentally challenged.

Description of the Related Art

A variety of software products exist for creating instructional content, which includes applications for creating audiovisual presentations such as the Microsoft Powerpoint® presentation system, Microsoft Word™, and other applications which allow one to record still or video image content (collectively, “image content”), and allow a user to assemble a collection of still or video image content (collectively, “image content”) in a user-defined sequence through a sequence of copy, paste, and/or modify input provided by the user. However, functionality is limited, and creating a presentation can be tedious because very many steps in the process require the user to manually provide much of the user input manually and record the image content manually. Relatively few steps in the creation of a Microsoft Powerpoint® presentation are automated.

Further improvement would be desirable in the generation of and providing of instructional content, particularly to people who are developmentally or mentally challenged.

### BRIEF SUMMARY OF THE INVENTION

In accordance with an aspect of the invention, a method, system and a tangible computer-readable storage medium are provided for performing a method for creating instructional content. In accordance therewith, instructions are executable by a processor to perform a method, which can include, for example: recording images of at least one human subject in motion; processing the recorded images to determine a sequence of gestures made by the human subject; synchronizing the recorded images with a narrative corresponding to the determined sequence of gestures into a synchronized image-supported narrative; and storing the synchronized image-supported narrative to permit reproduction of the synchronized image-supported narrative on a processor-enabled user device.

In accordance with another aspect of the invention, instructions may be executable to perform a method comprising: recording a sequence of at least one of user input, an application, a location or a link followed by the first user in using a first processor-enabled device; and generating verbal user instructions corresponding to the recorded sequence, the verbal instructions directing a second user to at least one of provide specific user input, utilize a specific application, visit a particular location or follow a specific link on a second processor-enabled device as a tutorial for the second user. The generating may include generating the at least one of the specific user input, specific application, particular location or specific link converted from the corresponding recorded at least one of the user input, the application, the location or the link followed by the first user.

In accordance with another aspect of the invention, instructions may be executable to perform a method comprising: recording a sequence of at least one of user input, an application, a location or a link followed by the first user in using a first processor-enabled device; and generating verbal user instructions corresponding to the recorded sequence, the verbal instructions directing a second user to at least one of provide specific user input, utilize a specific application, visit a particular location or follow a specific link on a second processor-enabled device as a tutorial for the second user. In accordance with such aspect, the generating may generate the verbal user instructions as spoken verbal instructions.

### BRIEF DESCRIPTION OF THE SEVERAL VIEWS OF THE INVENTION

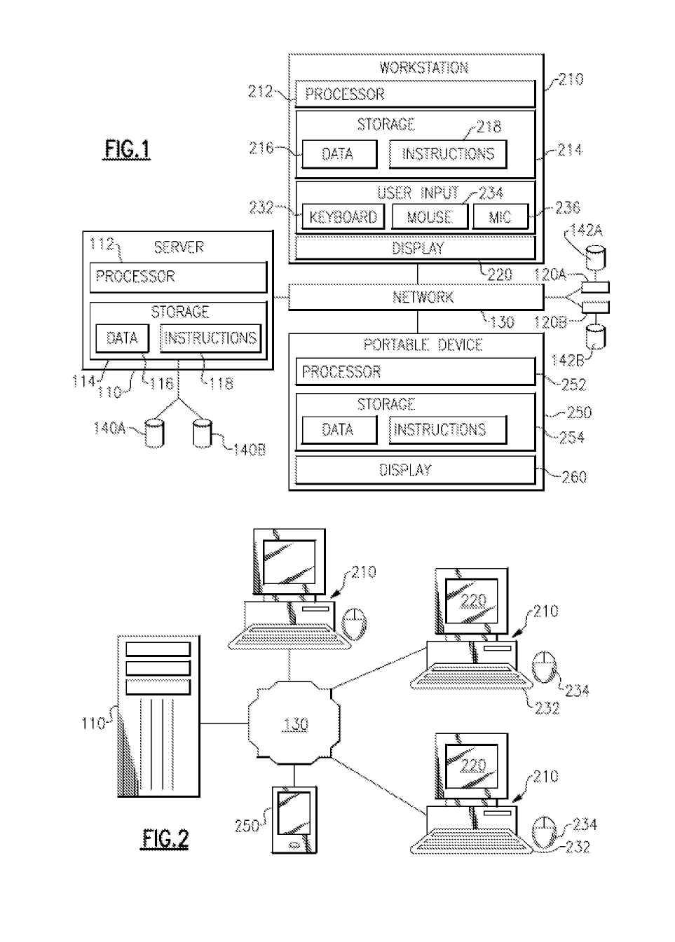

FIG. 1 is a schematic diagram illustrating a system in accordance with an embodiment of the invention.

FIG. 2 is a schematic diagram further illustrating a system in accordance with an embodiment of the invention.

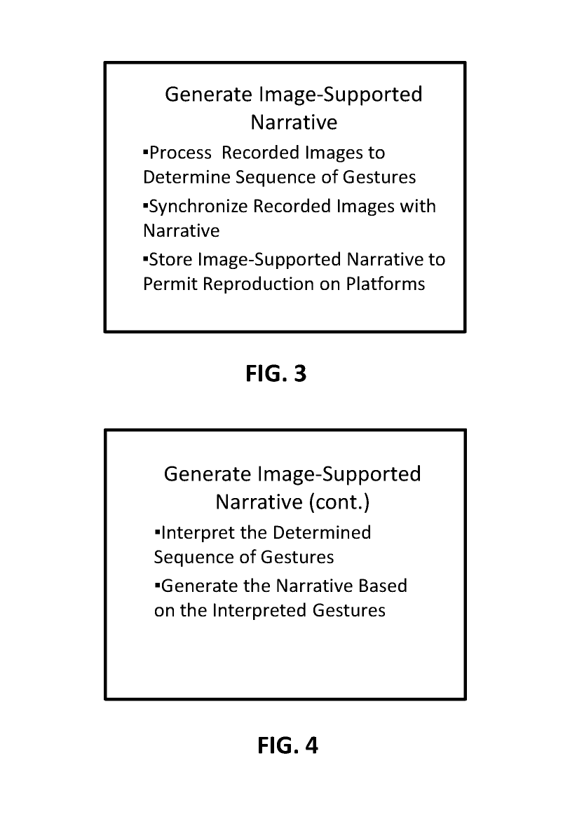

FIG. 3 is a diagram illustrating operation in accordance with an embodiment of the invention.

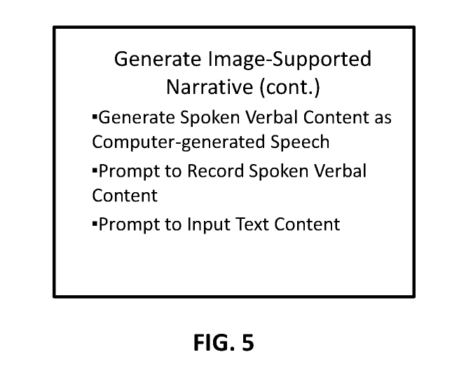

FIG. 4 is a diagram illustrating operation in accordance with an embodiment of the invention.

FIG. 5 is a diagram illustrating operation in accordance with an embodiment of the invention.

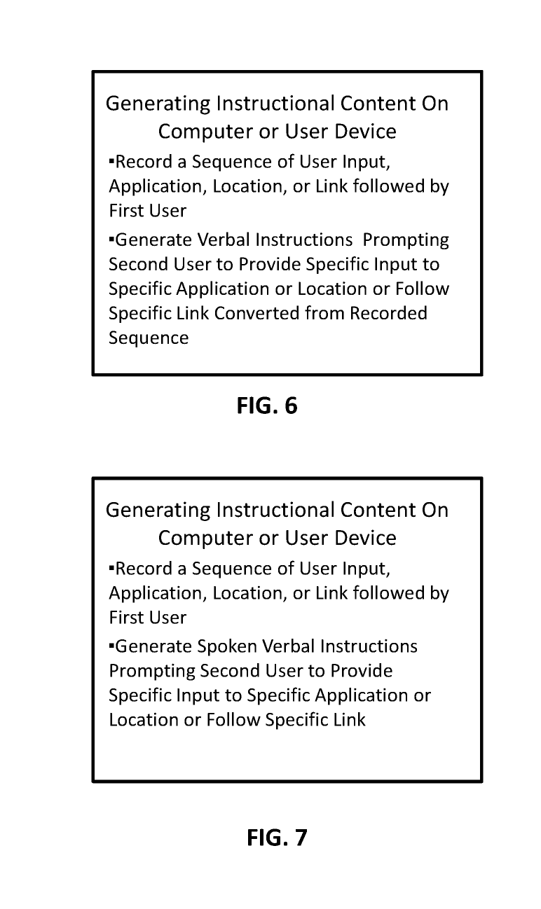

FIG. 6 is a diagram illustrating operation in accordance with an embodiment of the invention.

FIG. 7 is a diagram illustrating operation in accordance with an embodiment of the invention.

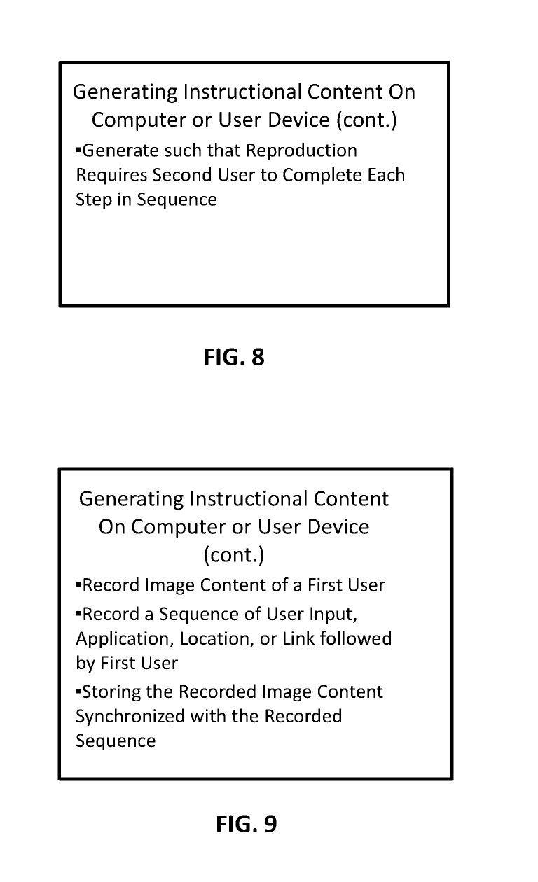

FIG. 8 is a diagram illustrating operation in accordance with an embodiment of the invention.

FIG. 9 is a diagram illustrating operation in accordance with an embodiment of the invention.

### DETAILED DESCRIPTION OF THE INVENTION

As shown in FIGS. 1 and 2, an instructional content generation and delivery system in accordance with an embodiment of the invention can include a computer or information processing system 110, for example, a computer having a processor 112 that may include one or more microprocessors. The computer 110 may function as a server to serve data and instructions to other computers. Storage 114 is available for storing and retrieving information used by the processor in a form which is readable by a computer. For example, storage 114 may be used to store data 116 and instructions 118 which are executable by the processor. The storage may include a tangible computer-readable storage medium such as a control store or content and information storage medium which may include, one or more of various magnetic, solid-state or optical media which provide read access or read-write access to data and instructions. The storage can also include one or more various portable memory media which can be read-write type, read-only type or a combination thereof, (e.g., a type of medium designed to be written only once but read many times), which can be recorded or read by electrical, magnetic, or optical means. In particular examples, the storage can be an internal or external memory drive or miniature memory card, which may include a solid-state memory storage drive, or a portable storage medium such as, for example, an SD card or drive, a compact disc (“CD”) or CD-ROM, digital versatile disc (“DVD”), magnetic tape media, etc., on which data or instructions or both can be recorded, read and, in some cases, executed by computer 110. The server 110 can be connected to additional storage 140A, 140B, which can be locally connected thereto. The additional storage can house one or more repositories of data, e.g., sources of test data such as one or more databases which track orders of tests and the results which are produced by the tests.

The instructions 118 can be any instructions which are executable by the processor, such as machine language instructions, or can be in any computer language such as source code compiled in advance of execution. Alternatively, the instructions can be in a computer language which is interpreted just before or at the time of execution. The data can be handled, i.e., written to storage or retrieved therefrom or modified based on the execution of the instructions 118 by the processor. Although the storage 114 is shown together with processor 114 in computer 110, the storage may or may not be housed together with the processor in the same physical unit.

In one example, networking equipment 130 (hereinafter, “network”) can be used to facilitate communication between the computer 110 and a plurality of auxiliary servers 120A, 120B, to which additional databases can be accessed in storage 142A, 14B. The network can also connect the server with one or more workstations 210, as seen in FIG. 2. The three workstations 210 shown in FIG. 2 are merely illustrative, as there can be fewer or more workstations capable of connecting to a server 110 or to each other via a network including switching equipment shown generally at 130. The network 130 can include one or more types of networks, such as, but not limited to: an enterprise network for the primary use or control by a particular organization, an intranet, i.e., a non-public network operating in accordance with the communication protocol known as Internet Protocol, or can be another type of a private or virtual private network, etc. The network (FIG. 2) can include portions extending within a public network such as the Internet. In such case, provisions can be made for secure connections through the Internet to satisfy security and quality-of-service goals. Communications between nodes can be facilitated by any of a variety of network communication protocols, such as, without limitation, wired or wireless communication protocols.

Executable instructions can be received in a processor-enabled device or “system” which may comprise workstation 210, server 110, or mobile user device or “portable device” 250 via electronic transmission from another location on network and stored tangibly in one or more storage media of workstation, server or mobile user device where the instructions may be executed to perform a method. Instructions can be executed on any such processor-enabled device even though not all instructions sufficient to perform all steps of a method may be stored on a particular processor-enabled device on which the instructions are executed.

Like computer 110, workstations 210 typically include a processor 212 (FIG. 1) and are capable of storing and retrieving data 216 and instructions 218 from associated tangible storage medium 214 which may be housed together with the processor or separately therefrom. The workstation typically includes a display 220, e.g., a screen capable of electronically displaying still or moving images or both, which is capable of displaying information to a user in a form readable or recognizable by the user. The display may be a touchscreen capable of registering user input at specific locations thereon which may be mapped by application software. Devices such as a keyboard 232 and a mouse 234, trackball, touchpad, or other pointing device may be provided for registering user input. The display, keyboard, mouse (or both) can together facilitate inputting of user information through a graphical user interface (“GUI”) such as a Windows® operating system-enabled display (Windows is a registered trademark of Microsoft Corporation). For example, user input may be of a type which causes the display of information presented to the user at a particular location on the screen to be modified when the user selects the location using a mouse or other pointing device.

In accordance with an embodiment herein, a mobile user device or “system” 250 (FIGS. 1-2), e.g., a smartphone, smartwatch, phablet, tablet, a user-wearable processor-enabled device, a portable user computer or combination of the same (individually and/or collectively, “mobile user device”, may have a wireless interface or a wired (electrical contact-based) interface may also be provided which can connect with computer 110 or a workstation 210 through network 130. Like computer 110, the mobile user device 250 can have a display 260 for presenting information to the user and has a user interface which may include one or more of a touchscreen, keyboard (not shown), keypad (not shown) and/or pointing device (not shown), microphone, among others, for registering user input therewith. Like computer 110, mobile user device 250 has a processor 252 and tangible storage medium 254, e.g., solid state storage device, for the storage of instructions for execution by processor 252 to retrieve, store or modify data. Although some functions may be indicated below as being performed on a server and other functions may be indicated as being performed on a workstation or mobile user device, various aspects of a system and method may be implemented by one or more processor-enabled devices as further described herein. Other reproducing equipment may be provided in network, such as a video screen or television on which instructional content can be reproduced.

Referring now to FIG. 3, an embodiment is provided for generating an image-supported narrative. In accordance with such embodiment, a content creator can record a sequence of still and/or video images (individually or collectively, “images”) of a human subject in motion. In some cases, the human subject can be the content creator or can be another individual. Then, the user can input the recorded images to a program operating on a processor-enabled device (e.g., computer and/or mobile user device). A content creator can also obtain, create, or record a narrative to accompany the recorded images and then designate such narrative to be combined with the recorded images. The images can be recorded either before or after the content creator designates a particular narrative to accompany the recorded images. A processor-enabled system, e.g., a processor-enabled device can then process the recorded images to determine a sequence of movements or gestures of the human subject from among the recorded images. Then, the processor-enabled device can synchronize the recorded images with the narrative designated by the content creator. The processor-enabled device to provide a synchronized image-supported narrative, after which the processor-enabled device then can store the synchronized image-supported narrative in a storage medium, e.g., a local and/or or server supported database to permit reproduction of the same on one or more platforms that the content creator designates. For example, the content creator may designate the synchronized image-supported narrative to be reproducible on computers and workstations that have a Windows® operating system platform or which have a MacOS® operating system platform; in such case the synchronized image-supported narrative can be processed for such platforms and then stored in a way that permits it to be reproduced on such platforms when requested by either of such platforms; alternatively, the content creator can designate the synchronized image-supported narrative to be reproducible on mobile user devices which have a variety of operating platforms and the synchronized image-supported narrative can be processed to enable it to be reproduced on such platforms.

Referring now to FIG. 4, in one embodiment, a processor-enabled device can process the recorded images to determine a sequence of human gestures corresponding to the recorded images. From the determined sequence of gestures, the processor-enabled device may in some cases obtain, generate and/or modify a corresponding narrative which may help explain the gestures and/or other characteristics or meaning of the recorded images. A processor-enabled device can then synchronize the recorded images with the narrative to create a synchronized image-supported narrative corresponding to the sequence of gestures determined from the recorded images. In this and each of the other cases herein, a “content creator” who records content, e.g., images, text, speech or other content, who may be the same or different from a user who is operating a processor-enabled device used for receiving input from the content creator and who may be different from a user who is operating a processor-enabled device used for organizing and assembling content from potentially multiple sources into one unified instructional presentation or tutorial.

Thus, in one example, a content creator can set up a video image recorder to record video of the content creator providing instruction to a developmentally or mentally challenged person on how to operate a microwave oven (hereinafter, “microwave”). For example, the challenged person may be someone having memory difficulties such as a person with dementia, or may be someone who has difficulty learning or remembering a process. The video image recorder may in some cases be a function integrated in the mobile user device, although the function can be implemented by any suitable device. As the content creator moves about in a way that operates the microwave (or otherwise, in a way that simulates the content creator's operating the microwave), the video image recorder records a sequence of still and/or video images of the content creator. For example, the content creator may move through a sequence of positions and actions in which the content creator demonstrates through his or her actions how to open the microwave, place an item to be heated in the microwave, set a heating time, start the heating in the microwave, understand when the heating is finished, and show how to remove the heated item safely after heating. The video image recorder thus records images while the content creator is performing these actions.

A processor-enabled device then processes the recorded images to determine a sequence of gestures that correspond to the recorded images. Thus, in this example, through an image recognition facility such device may recognize that the content creator has an item in his or her grasp and then opens the microwave door and places such item inside the microwave, then shutting the door. In such case, the system may determine gestures as follows: “Open door to microwave. Grasp item and place it in the microwave. Close microwave door firmly.” The system may recognize further gestures based on further movement of the content creator and further detail in images of the content creator and microwave. Such device may further recognize action which sets a heating time by the content creator pressing a series of keys on a keypad of the microwave. In such case, the processor-enabled device may determine from the content creator's actions the following gestures: “Set a heating time. Press the ‘plus’ button to put one minute as the heating time. Press the ‘plus’ button to add another minute to the heating time.” Such device may further be operable to recognize visual symbols or numbers on a timer display of the microwave and recognize one or more of: the microwave having counted down to zero and turned off. When the content creator then waits one more minute before opening the microwave door and carefully grasps the heated item (e.g., at a corner of the item), the system may determine the following: “Wait until the microwave counts down and turns off. Then wait one more minute. Then open the door and carefully grasp the heated item by a corner of the item. Carefully remove the heated item from the microwave.” In this case, the determined sequence of gestures are specific to the actions performed by the content creator, and are sufficient to explain the content creator's actions. In such case, through image recognition techniques and gesture recognition, a narrative can be created that corresponds to the content creator's actions. A processor-enabled device then can synchronize the recorded images with the created narrative to provide a synchronized image-supported narrative.

In the above example, a high capability is provided for recognizing gestures and actions. Should the a more limited capability be present, in one example, the processor-enabled device may determine a more limited set of gestures form the content creator's gestures such as: “Open microwave door. Insert item in microwave and close door. Operate keypad. Wait some time after microwave shuts off, then open microwave door. Remove item.” In this second case, gestures can be determined more generically, and the content creator must add additional detail to complete a narrative for accompanying the recorded images. Referring to FIG. 5, the content creator can be prompted to help complete a narrative by providing spoken or written verbal content. Thus, in this case, the content creator can be prompted to provide a spoken verbal narrative of her actions either as she performs them, or before or after performing the actions. For example, the content creator can use a microphone and a sound recording facility associated with the processor-enabled device to record a narrative as follows:
1. “Set a heating time. Press the ‘plus’ button to put one minute as the heating time. Press the ‘plus’ button to add another minute to the heating time.”
2. “Wait until the microwave counts down and turns off. Then wait one more minute.”
3. “Then open the door and carefully grasp the heated item by a corner of the item. Carefully remove the heated item from the microwave.”

With continued reference to FIG. 5, in a particular embodiment, the system is capable of generating verbal content in form of computer-generated speech. In a particular embodiment, the system is capable of generating written verbal content, and the system is capable of reproducing, e.g., displaying the written verbal content in a written form that is readable by a human. In one embodiment, the content creator can be prompted to provide written verbal content, i.e., text, and the processor-enabled device can then synchronize the written verbal content with the recorded images to form the synchronized image-supported narrative.

When the synchronized image-supported narrative is reproduced, the verbal content can be reproduced in a form the receiver (i.e., a user of a system such as a processor-enabled device) can understand either in form of a written message in a human-readable natural language such as, for example, English, or alternatively, in form of speech uttered by a human speaker or, alternatively computer-generated speech.

Referring now to FIG. 6, in another embodiment of the invention, a processor-enabled system, e.g., processor-enabled device can be used to generate instructional content, e.g., a presentation or tutorial. The processor-enabled device can be a computer, a user computer, or any mobile user device, such as for example, any of the above-mentioned mobile user devices or other such devices which may exist. In this case, using a processor-enabled device, a content creator records a sequence of user input, the identity of an application utilized on the processor-enabled device, and may record locations or links which are followed by the content creator. The locations or links can be references to an item available internally within an organization through a local network or intranet, or may be references to items available through the Internet, such references which are or may include a Uniform Resource Identifier (URI) or Uniform Resource Locator (URL). The processor-enabled device can then process the recorded sequence of user input, identity of the application(s) used, locations or links to create instructional content, e.g., a tutorial, to be reproduced by a viewer (i.e., a “second user”) of the tutorial to follow and use in learning a procedure for doing something.

While recording the sequence of user input, the processor-enabled device can generate a series of verbal instructions which can be synchronized to the sequence of user input, application(s) and links which can help explain the procedure being taught. In one example, a human operator such as a content creator can record spoken verbal instructions to be synchronized with the recorded sequence. In another example, the processor-enabled device can recognize the content or references in the recorded sequence and automatically generate a series of verbal instructions, e.g., either as spoken verbal instructions for output as computer-generated speech (FIG. 7) or as written verbal instructions, e.g., text on a screen, for guiding the viewer of the tutorial (i.e., a “second user”) as the viewer navigates each step of the sequence.

In a particular example, referring to FIG. 8, a processor-enabled system, e.g., a processor-enabled device can generate the tutorial in a way that requires the viewer (second user) to complete each step in the sequence before proceeding. Even though all steps, user input, application(s) used, link(s) followed by the first user or content creator making of recorded sequence are recorded, the instructional content is processed such that the viewer or second user cannot proceed to the next step unless the viewer completes each step satisfactorily by following the steps required in the instructional content.

Referring now to FIG. 9, in another example, the first user or content creator can record image content of herself or another. For example, the image content can be recorded via an imaging device associated with the system, e.g., processor-enabled device. A processor-enabled device can then synchronize the recorded image content with verbal instructions that are generated as part of the instructional content, and the instructional content can then be prepared for storing in a way that it can be reproduced for viewing and use by a second user.

While the invention has been described in accordance with certain preferred embodiments thereof, those skilled in the art will understand the many modifications and enhancements which can be made thereto without departing from the true scope and spirit of the invention, which is limited only by the claims appended below.

1. A tangible computer-readable storage medium for generating instructional content for the challenged, comprising
a set of instructions executable by a processor to perform a method, the method including recording images of at least one human subject in motion;
processing the recorded images to determine a sequence of gestures made by the human subject;
synchronizing the recorded images with a narrative corresponding to the determined sequence of gestures into a synchronized image-supported narrative; and
storing the synchronized image-supported narrative to permit reproduction of the synchronized image-supported narrative on a processor-enabled user device.

2. The tangible computer-readable storage medium of claim 1, further comprising interpreting the determined sequence of gestures by a processor, and generating the narrative by a processor based on the interpreted determined sequence of gestures.

3. The tangible computer-readable storage medium of claim 2, wherein the narrative includes spoken verbal content, and the reproduction includes reproduction of the spoken verbal content in audible form.

4. The tangible computer-readable storage medium of claim 3, wherein generating the narrative includes generating the spoken verbal content as computer-generated speech.

5. The tangible computer-readable storage medium of claim 3, wherein generating the narrative includes prompting a content provider to record the spoken verbal content to be included in the image-supported narrative.

6. The tangible computer-readable storage medium of claim 2, wherein the narrative includes written verbal content, and the reproduction includes reproduction of the written verbal content in human-readable form.

7. A tangible computer-readable storage medium, comprising:
a set of computer-readable instructions executable by a processor to perform a method, the method including
recording a sequence of at least one of user input, an application, a location or a link followed by the first user in using a first processor-enabled device;
generating verbal user instructions corresponding to the recorded sequence, the verbal instructions directing a second user to at least one of provide specific user input, utilize a specific application, visit a particular location or follow a specific link on a second processor-enabled device as a tutorial for the second user,
wherein the generating includes generating the at least one of the specific user input, specific application, particular location or specific link converted from the corresponding at least one of the user input, the application, the location or the link followed by the first user.

8. The tangible computer-readable storage medium of claim 7, wherein the first and second processor-enabled devices have different operating platforms, and the generating generates the at least one of the specific user input, specific application, particular location or specific link converted to a form compatible for operation of the different operating platform of the second processor-enabled device.

9. The tangible computer-readable storage medium of claim 7, wherein one of the first and second processor-enabled devices is a user general purpose computer, and one of the first and second processor-enabled devices is a mobile user device.

10. The tangible computer-readable storage medium of claim 7, wherein the generating generates the verbal user instructions as spoken verbal instructions.

11. The tangible computer-readable storage medium of claim 10, wherein the method further comprises recording image content of the first user while recording the sequence, and the method further comprising storing the recorded image content for later reproduction with the generated verbal instructions as a tutorial for the second user.

12. The tangible computer-readable storage medium of claim 10, wherein the generating generates a sequence of steps followed on a processor-enabled device, wherein the generating is performed such that when the generated sequence of steps is reproduced, the second user must follow each step to permit the second user to advance to the next successive step.

13. A processor-enabled system for generating instructional content for the challenged, comprising
a processor; and
a set of instructions executable by the processor to perform a method of generating instructional content, the method including
recording images of at least one human subject in motion;
processing the recorded images by the processor to determine a sequence of gestures made by the human subject;
synchronizing the recorded images with a narrative corresponding to the determined sequence of gestures into a synchronized image-supported narrative; and
storing the synchronized image-supported narrative to permit reproduction of the synchronized image-supported narrative on a processor-enabled user device.

14. The system of claim 13, further comprising interpreting the determined sequence of gestures by the processor, and generating the narrative by a processor based on the interpreted determined sequence of gestures.

15. The system of claim 14, wherein the narrative includes spoken verbal content, and the reproduction includes reproduction of the spoken verbal content in audible form.

16. The system of claim 15, wherein generating the narrative includes generating the spoken verbal content as computer-generated speech.

17. The system of claim 15, wherein generating the narrative includes prompting a content provider to record the spoken verbal content to be included in the image-supported narrative.

18. The system of claim 14, wherein the narrative includes written verbal content, and the reproduction includes reproduction of the written verbal content in human-readable form.

19. The system of claim 14, wherein the method further comprises recording image content of the first user while recording the sequence, and the method further comprising storing the recorded image content for later reproduction with the generated verbal instructions as a tutorial for the second user.

20. The system of claim 19, wherein the generating generates a sequence of steps followed on a processor-enabled device, wherein the generating is performed such that when the generated sequence of steps is reproduced, the second user must follow each step to permit the second user to advance to the next successive step.
